(19) United States
(12) Patent Application Publication
(10) Pub. No.: US 2006/0247938 A1
(43) Pub. Date: Nov. 2, 2006

(54) Method and system for activity reporting

(75) Inventor: Tracy E. Thieret, Webster, NY (US)

Correspondence Address: PEPPER HAMILTON LLP, ONE MELLON CENTER, 50TH FLOOR, 500 GRANT STREET, PITTSBURGH, PA, 15219, US

(73) Assignee: Xerox Corporation

(21) Appl. No.: 11/116,896

(22) Filed: Apr. 28, 2005

(51) Int. Cl. G06Q 99/00

(52) U.S. Cl. 705/1

(57) ABSTRACT

A method for producing an activity report is disclosed. The method includes identifying at least one device in a system, generating the activity report with the activity report including information about the at least one device in the system, delivering the generated activity report to a remote location from the at least one device and providing recommendations about the at least one device generated by a recommendation system utilizing the information from the activity report.

### BACKGROUND

1. Technical Field

The disclosed embodiments generally relate to methods and systems for document and equipment management. More particularly, the disclosed embodiments relate to methods and systems for generating an activity report including recommendations for devices so that strategic decisions may be made about the devices and their usage.

2. Description of Related Art

Regardless of the trend to move to an electronic-based environment, it remains necessary for businesses to continuously utilize printing and copying services within the organization. And while printing and copying are critical and necessary services, they are commonly managed in an organization by an individual who is physically removed from performing such services. Accordingly, these services are provided with neither a clear understanding of the costs involved nor a defined strategy for managing them. Therefore, managers are faced with unbounded costs as well as monthly surprises in their invoices. This happens because business personnel or managers do not have the necessary information to determine whether the copying/printing resources that they purchase and maintain are being used effectively. The purchase decisions are typically based on intuition rather than on an analysis of costs and usage of the devices. For example, device placement in an organization is often based on space availability rather than on where the device or devices are most needed. This again is due to lack of factual data about the device and its usage.

Most current office devices provide a detailed report on the usage of a specific or individual machine. These reports may be obtained by physically going to the machine and using the front panel to access a menu that prints the report or by accessing the web pages service by the device's internal web server. The reports are usually quite detailed but almost always provide only accumulated information, such as number of pages printed, from the time of install or, when appropriate, the last consumables replacement. The data reported usually is accumulated from machine installation, and the customer using the data typically will maintain previous reports for comparison purposes. Thus, insufficient as well as inaccurate information may be utilized in making decisions. For example, U.S. Pat. No. 6,208,428, entitled “Printing System and Charging Method Thereof” describes a printing system having a higher rank device that acquires, stores, calculates and records the accumulated number of prints from every printing data producer.

Additional restrictions may include that the device needs to be capable of network transmission using standard network protocols. The copier and other unconnected machines in the field also may be constrained because they fail to supply either the connectivity requirement or the transmission standards requirement. Lack of standard connectivity means restricts the device's use to the existing, mostly manual, work process. For such devices, the only available possibility is a primarily manual process that prints out the available information and permits scanning the page(s) into an application that extracts the data by optical character recognition and makes it available for additional uses. An automated means of collecting the data from the unconnected machine may be performed by providing an add-on connectivity enhancement to connect the existing data sources inside this class of otherwise unconnected machines.

All of these limitations result in an inefficient use of time and cost of the devices, as well as of the individual managing the devices. The information useful to making strategic decisions about the devices is, for the most part, already available on the devices. In fact, many networked marking devices, such as printers, copiers, multifunction (copy, print, fax) machines in many cases are capable of reporting the necessary information on an individual device basis. This information, however, is not provided in a usable format nor does it include aggregate information pertaining to multiple devices that enables decision makers to construct strategies and make informed decisions about their device and business needs.

Accordingly, there is a need for developing a report and a method and system for providing timely factual information and data about the population of devices in use so that an individual may develop and implement a document management system providing the most efficient and cost-effective approach to manage the devices within an organization.

### SUMMARY

An embodiment includes a method for producing an activity report. The method may include providing a reporting application. At least one device in a system may be identified. The activity report may then be generated. If multiple devices exist that are of interest to a user responsible for a company's document strategy, the activity report may include aggregate information about a plurality of devices in a network. The generated activity report may be delivered to a remote location from the at least one device. Recommendations about the at least one device may be provided. The recommendations may be generated by a recommendation system utilizing the information from the activity report. The method may further include the step of delivering the activity report in at least one format including spreadsheet files, human readable text, or preformatted formats readable by other applications. The method may further include the step of delivering the activity report by email, web page, hard copy or a combination thereof.

The step of identifying at least one device in the system may further include identifying a grouping of devices including desktop devices or a number of devices interconnected in a network system. The at least one device may include a printer, a scanner, a fax machine, a multifunction device, a cell phone, a network router, a network switch, a network computational device including servers, workstations and the like, a network file system or a combination thereof. The information in the activity report and the recommendations provided may allow a user to make a strategic decision about efficient use of the at least one device. The activity report may include a summary of the information from at least weekly readings of usage of the at least one device, charts, graphs, tables or combinations thereof. The weekly readings may be periodic. The activity report may be generated at least monthly.

The recommendation system may include a recommendation engine for producing recommendations. Prior to generating the activity report, the recommendation engine may test to see if the recommendation has been implemented within an identified time before restating the recommendation. The recommendation system may provide a user with an interface having options for at least accepting or rejecting the recommendation. The activity report may be generated by a static or dynamic reporting process. The reporting application may include a software development kit for third-party application development, for example, to enable the user to develop his or her own applications that utilize the data supplied by the reporting application.

Another embodiment includes a method for implementing a document management strategy. The method may include providing a reporting application, collecting data from at least one device within a network, generating an activity report, and utilizing the activity report to make decisions. The activity report may include information about the at least one device and recommendations for increasing efficient usage of the at least one device. The activity report recommendations may provide data-based incentives and be utilized for decisions and actions by, for example, the appropriate strategic decision makers within an organization.

The network may include a grouping of devices or a number of devices interconnected in a network system. The at least one device may include a printer, a scanner, a fax machine, a multifunction device, a cell phone, a network router, a network switch, a network file system, a network computational device or a combination thereof. The decisions may include performing maintenance, purchasing new devices, upgrading the at least one device, replacing the at least one device, moving the at least one device or a combination thereof. The activity report may include a summary of the information obtained from at least weekly readings of usage of the at least one device, charts, graphs, tables or combinations thereof. The activity report may be generated by a static or dynamic reporting process. The activity report may be delivered in at least one format including spreadsheet files, human readable text, or preformatted formats readable by other applications. The activity report may be delivered by email, web page, hard copy or a combination thereof.

In another embodiment, there is an activity report for use in an equipment management system. The activity report provides information about at least one item of equipment in a network and also provides recommendations. The user may be provided with the information to make a strategic decision about the effectiveness of the at least one equipment in the network. The network may include a grouping of equipment or multiple equipment interconnected in a network system. The activity report may include a summary of the information obtained from at least weekly readings of usage of the at least one equipment, charts, graphs, tables or combinations thereof. The activity report may be delivered in at least one format including spreadsheet files, human readable text, or preformatted formats readable by other applications. The activity report may be delivered by email, web page, hard copy or a combination thereof.

### BRIEF DESCRIPTION OF THE DRAWINGS

Aspects, features, benefits and advantages of the embodiments of the present invention will be apparent with regard to the following description, appended claims and accompanying drawings where:

FIG. 1 illustrates a chart in an activity report according to one embodiment of the disclosure.

FIG. 2 illustrates a chart in an activity report according to another embodiment of the disclosure.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to a “device” is a reference to one or more devices and equivalents thereof known to those skilled in the art, and so forth. The term “information” and “data” will be used interchangeably herein. Unless defined otherwise, all technical and scientific terms used herein have the same meanings as commonly understood by one of ordinary skill in the art. Although any methods, materials, and devices similar or equivalent to those described herein can be used in the practice or testing of embodiments of the invention, the preferred methods, materials, and devices are now described.

While the term “user” will be used in the disclosure below, “user” will include reference to any person or person, such as office managers, office employees, solo business owners, customers and the like, all of which may be used interchangeably and is to represent any individual with a device. The use of the term “device”, “marking device”, “machine” and “equipment” will be used interchangeably and is to encompass all devices including but not limited to printers, scanners, fax machines, multifunction devices, network routers, network switches, network computational devices including servers and workstations, network file systems and the like, including combinations thereof “Aggregated report” may be used interchangeably herein with “activity report”, “productivity report”, “report” may include more than one type of report document, for example, multiple charts. “Document production” describes, for example, printed papers/documents, scanned papers/documents, faxed papers/documents, emailed papers/documents, and the like.

The disclosure is generally directed to providing a strategic decision maker, such as an office manager, with a report including usage information about an individual device as well as a collection of devices, and recommendations to increase efficiency of the devices. The activity report provides users the information necessary to monitor and track the document production activities within an organization. In particular, the report may include aggregated productivity and usage information with assessments of the state of each device and recommendations for further action in view of the data about how the devices are being utilized. The report may be provided to the user automatically at specified time intervals or on demand.

An embodiment of the disclosure may be directed to a method of producing an activity report. The method includes the steps of providing a reporting application and identifying at least one device in a system. An activity report may then be generated. The activity report includes information about the at least one device in the system. Recommendations generated by a recommendation system then may be provided utilizing the information from the activity report. These steps are described in more detail hereinbelow.

A reporting application for collecting data and information about the device may be provided. The reporting application, or application as referred to throughout the disclosure, used to generate reports may be provided separate from the device or may be an integral part of the device. The application allows information from multiple devices to be aggregated. Alternatively, where only one device of interest may exist, the device itself may provide the necessary information about its own behavior when the application is an integral part of the device.

If the reporting application is a separate entity from the device, it may be delivered through a variety of means. In an embodiment, an organization external, i.e. offsite, to the customer with the devices may provide the software services, such as ASP (Application Service Provider). Here the organization may host the application on its own servers at the organization's location for the customer's use at the customer's location. The devices may then communicate with the server. This arrangement allows for new and updated features to be available on the organization's servers and deployed immediately and uniformly throughout an organization's customer base. This delivery option may be beneficial as the maintenance concerns for the customer are eliminated because the organization would be responsible for handling the hardware and software aspects of the application externally or offsite from the customer. All communication between the devices and the application would then occur between the customer site and the organization's ASP servers external to the customer's site.

Another delivery option for the reporting application may include hosting the software on a server at the customer's site. In this instance, the customer may designate a computer server for the application to reside. Communications between the devices and the application, for most of the features, operate within the customer's site. Certain advanced features may run external to the customer's site, or may be supplied to the customer for updates to the application.

An alternative approach, may be for the organization to provide a plug-in for a third-party device and its associated asset management software packages, such as IBM/Tivoli™, CA Unicenter®, and HP OpenView®. In this case, the functionality may be delivered through the existing management software application's user interface.

In other embodiments, third-parties may also provide services and/or applications to customers. In this business area, customers often develop their own applications for their document processing devices. The comprehensive device population database that is enabled by remote data acquisition and processing capabilities may be turned into a knowledgebase and used to develop value-added applications that provides useful functions to customers that are not developed by the specific document management organization. Then, third-parties and a document management organization may create independent applications that access the information collected in the databases.

Optionally, Application Programming Interfaces may be developed and provided to third-parties to enable communication for software on different platforms. An Application Programming Interface includes the definition of the interfaces to a set of callable routines. The interface definition for each callable routine may provide: (1) the name of the routine recognized by the called entity; (2) a textual description of what the routine is designed to do; (3) the arguments expected by the routine both enumerated and defined including the units (feet, sheets, pixels, furlongs/fortnight) of representation; and (4) the returned value(s) from the routine similarly enumerated and defined. A Software Development Kit (SDK) may also be provided to a third-party that includes both documentation and linkable libraries that permit access to the database as well as other features.

With the reporting application provided, devices in a system, for example, a network, may then be identified or discovered. The term network includes the following: one or more single stand alone devices having connectivity capabilities, a grouping of devices, as well as devices interconnected on a network system, for example, multiple devices interconnected on an intranet, and the like. Depending on the capabilities of the devices in an organization, it is necessary to determine which devices are available to be included in the capturing of data for generating the report. In a web service application environment, for example, some devices may be capable of self-identification. This is beneficial due to high network bandwidth efficiency because the devices advertise their services to others on the net.

Other connected machines in the field and legacy devices support some level of SNMP (Simple Network Management Protocol) capability. In this instance, it may be necessary to find these machines by the application through a polling mechanism. In order to identify the eligible machines for producing the activity report, the application may seek out appropriate devices on the customer's network and include them in the scope of the requested report. A customer's existing third-party application may optionally have its own discovery mechanism for identifying the devices. Alternatively, the device may identify itself to the system, thereby eliminating the need for traditional device discovery mechanisms. In this instance, the device may be self-declaring and may be authenticated by reference to the installation database or by other suitable means.

Device clustering or the grouping of devices, may also occur where the user can group devices together into groups for reporting purposes. This may occur, for example, in various ways. One manner in which this may occur is for the customer to arbitrarily define the device groupings. For example, customers may define device groupings using criteria of their choosing, such as device type (i.e., printer, scanner, etc.). These device groupings may be constructed manually and maintained until the customer deletes a definition. In the alternative, the device groupings may be dynamically defined. For example, dynamic groupings may be provided based on any device configuration or stated parameter. Examples of such parameters include physical location, print volume over a period of time, state of repair (such as red/yellow/green), low on paper/toner, available media stocks loaded, as well as others. For example, the devices including, for example, printers, multifunction devices, etc. . . . located within one floor or an area of an organization may be grouped together. Alternatively, the devices within an organization may be a device grouping. These device groupings after being specified may function similar to the other device groupings and may in addition be selected or designated to be managed in a number of ways. For example, the device grouping may be selected to be maintained, i.e., saved until deleted, or transient, i.e., saved for a single or specified use only. Thus, a customer may request a report for all devices that have run more than a specified number (e.g., 10,000) of prints in the past week and have had less than a specified period (e.g., 2 hours) of downtime, or any other possible combination of parameters thereof, in order to define a dynamic group.

Accordingly, users as well as document management organizations may profit from having a profile of a number of or all of the devices with an organization. This profile including the information and data of the devices may be compiled in an activity report.

Productivity reporting or production of the activity report provides decision makers aggregate information for multiple devices. The report provides a summary of the activity of multiple devices from at least weekly readings of usage of the devices. The weekly readings may be periodic. The aggregate information may include multiple data as described in further detail herein below, such as number of prints, time in use, peak printing times, etc. . . . for multiple devices. The functionality of the report may be limited both in the scope of the data provided and the time interval for the report. The activity report may be customized by the user by selecting any subset of the data in the standard report and by modifying the time interval or report period. The layout, format, or content of the report may also be specified. For example, the content of the activity report may include machine serial number, IP address, physical location, controller firmware version level, asset number (as entered by customer), installation date, total volume/impressions (lifetime), all billing meters, simplex/duplex sheets, monochrome/color pages, media size histograms, job lengths, number of toner cartridges used (i.e., installed), current device state (up, down, transitioning), print page area coverage and toner usage averages; and for multifunctional devices modal usage data may include number of copies, number of faxes sent, number of faxes received, number of pages scanned; for fax devices, the device may provide data including baud rate usage and long distance usage in addition to quantity in and quantity out; for scanners, data collection include number of pages scanned and resolution usage, reporting date and time, time of last report, and other information available from the devices and selected by the user.

As indicated above, the reports may be dynamically constructed. In many situations, having data presented in a predictable format is useful because of the contextual framework is constant and the data is in the same place every time. In other situations, static formatting for productivity reports may be unproductive after seeing the same variables in the same format numerous times. In these cases, technologies that provide parameterized or dynamic formatting of the report are available. Examples of dynamic document formatting are described in U.S. patent application Ser. No. 10/202,207, filed Jul. 23, 2002 entitled “System and Method for Dynamically Generating a Style Sheet”; U.S. patent application Ser. No. 10/202,183, filed Jul. 23, 2002 entitled “System and Method for Constraint-Based Document Generation”; U.S. patent application Ser. No. 10/202,247, filed Jul. 23, 2002 entitled “System and Method for Dynamically Generating a Style Sheet”; and U.S. patent application Ser. No. 10/209,626, filed Jul. 30, 2002 entitled “System and Method for Fitness Evaluation for Optimization in Document Assembly”, all of which are herein incorporated by reference. Each aspect of the dynamic report may be assigned a priority specific for this customer or report. Important recommendations may be prioritized first and the supporting data summarized below followed by the other elements of the report.

In an embodiment, the activity report may be provided by a marking device vendor. The content of the activity report may include information on the vendor's devices or may include information on the devices that are not provided by the reporting application's vendor. When the reporting application is supplied by a marking device vendor, the activity report generated may include devices supplied by a competitor, such as printers, multifunction devices, and the like. For example, competitor devices may also be identified by the application so that they may be included with existing devices in the report generated. The inclusion of reports about competitive devices enhances the activity report application so that customers have a single tool that encompasses all their devices.

The report may be generated on a scheduled time interval or may be generated on demand. Reports generated on a scheduled time provide flexible reporting of individual or aggregate data on a schedule or specified time interval, without human prompting. For example, the information relating to the activity of the device may be collected at a time interval such as biweekly during an off-peak network time period, such as 2 a.m. The content of the automatically generated activity report may be as flexible as those that are currently requested directly. The content of this report may be specified as well as its frequency. The activity report may be produced automatically and communicated electronically. For example, a user may request the activity report to be generated. Alternatively, computers or computational entities generated may also request reports by submitting a properly authenticated and formatted request to the database query, Application Programming Interface. A computational application may specify the parameters for the report and provide additional analysis which may be communicated to the strategic decision makers.

In another embodiment, the data or activity report may be generated on demand. For example, for any report request, the user may be prompted and asked to use data already collected or to update the data immediately to provide a report that reflects the current situation at the time of the report request. A default may be specified to use existing data. For current data, the report generation application may estimate the time to complete the data collection and analysis. For example, if the time is greater than, for example, about 1 minute or some suitable time interval, the user may be given the option of waiting, letting the process proceed in the background with an alternative delivery means or canceling the request. Some requests may require extensive data collection and computation and these may be deferred for overnight delivery in order to maintain server availability for other, less demanding requests.

Generally, the application may generate the activity report and provide data on a daily or less frequent basis. A daily frequency of data collection is adequate to provide most of the features. However, there are certain important areas of functionality that may require that the machine either communicate or log data more frequently. For example, the queue length may be monitored hourly in order to assess the maximum usage density for devices.

The generated activity report about the at least one device may be delivered to a remote location from the at least one device. For example, the generated activity report may be delivered to a user or office management personnel. The generated activity report may then be delivered by a variety of ways. For example, the user may be able to select any of the following way in which to deliver the report: e-mail; export, such as Excel or Access, an appropriately formatted file; save to file in a specified format; a hard copy print, for example, a paper report; publish to a web site as formatted HTML or any other suitable format and communication means according to the desire of the requestor of the report. The activity report may also be delivered in a number of formats including, but not limited to spreadsheet files, human readable text, and preformatted formats readable by other application.

The application may also provide a mechanism to create, save and recall report templates. That is, the application may provide customers an easy to use method to create or generate a report or report template using available data elements (stored or collected by the application's supporting database). Customers may be able to select and deselect elements to be reported to create a custom report and choose the data format for the report, for example, HTML or CSV (comma separated values). The customer may then generate the report in the desired format and view it or distribute it by any means and formatting available. The customer may then be able to save the created report template/query for additional and future use. Each template may itself be published for the use of others or retained for use only to the owner.

The report also may include recommendations based on the information in the report. The activity report includes recommendations about what should be done to improve the effectiveness of the document and equipment management system in accordance with the company document strategy. For example, the activity report may include information on which devices are being overused and provide suitable recommendations. The report may include information and recommendations relating to average job completion time; the distribution of completion times; the maximum waiting time for job completion; and which printers are causing excessive waiting times. For example, the daily or weekly average usage of the device, information traditionally provided, may not be the appropriate metric for a machine speed upgrade recommendation. Therefore, the user compares the device's activity level to the waiting time information to make a determination if a machine speed upgrade is necessary. Additionally, it may be necessary to obtain hourly readings of certain data to provide this information. Other recommendations may include recommending a machine with more capability if there are certain times of day when a particular device is typically overused.

The recommendations may be provided upon each print out of the report. Optionally, a time interval for printing the recommendations on the report may be identified. The recommendations may be generated by a recommendation system including a recommendation engine. The recommendation engine may learn the customer's work practices and make suggestions based on significant changes in the normally observed behaviors. For example, the recommendation engine may include sets of hypotheses that may be formulated for testing by data mining or similar techniques each day and anomalies reported when confidence interval criteria are exceeded. The recommendation engine preferably remembers recommendations previously made and tests to determine whether the recommendations have been implemented within a specified time before restating the recommendation. For example, the recommendation system may accept a response from the customer regarding whether the customer wanted to, for example, act on the recommendation, ignore it for the time being, be reminded later, or never see it again. The recommendation engine may provide customers and document management organizations with abstracted information without human intervention. Additional hypotheses may be entered for analysis as desired.

Another embodiment of the disclosure includes implementing a document management strategy. A document management strategy may include principles of operation for a plurality of marking devices present in an environment, for example, within an organization. Principles of operation may include variable and/or goals such as cost minimization, device accessibility, maximum waiting time for document completion, and other strategic parameters suitable for policy deployment within an organization. For example, an organization may consume up to 20% of its revenues on printing and copying activities. By receiving and reviewing the activity report including aggregate information about multiple devices, an office manager for example, is able to make a determination for policies within an organization to improve device and cost-efficiency. For example, based on the information in the activity report, a new organization policy in accordance with the document management strategy may be implemented. This policy may be, for example, that the organization will only print in duplex or no color printing is allowed.

The method of implementing a document management strategy includes providing a reporting application, collecting data from at least one device within a network, generating an activity report, and utilizing the activity report to make decisions. The activity report includes information about the at least one device and recommendations for increasing efficient usage of the at least one device.

The network may include a grouping of devices or a number of devices interconnected in a network system. The at least one device may include a printer, a scanner, a fax machine, a multifunction device, a network router, a network switch, a network computational device or a combination thereof. The decisions may include performing maintenance, purchasing new devices, upgrading the at least one device, replacing the at least one device, moving the at least one device or a combination thereof. The activity report may include a summary of the information obtained from at least weekly readings of usage of the at least one device, charts, graphs, tables or combinations thereof. The activity report may be generated by a dynamic reporting process. The activity report may be delivered in at least one format comprising spreadsheet files, human readable text, or preformatted formats readable by other applications. The activity report may be delivered by email, web page, hard copy or a combination thereof.

In another embodiment, there may be an activity report for use in an equipment management system. The report provides information about at least one piece of equipment in a network and recommendations. The user thereby may be provided with the information to make a strategic decision about effectiveness of the at least one equipment in the network. The network may include a grouping of equipment or a multiple equipment interconnected in a network system. The activity report may include a summary of the information obtained from at least weekly readings of usage of the at least one equipment, charts, graphs, tables or combinations thereof. The activity report may be delivered in at least one format comprising spreadsheet files, human readable text, or preformatted formats readable by other applications. The activity report may be delivered by email, web page, hard copy or a combination thereof. The information in the report may be provided to a user who may then be able to make a determination based on the information and recommendations as to efficient use of the devices.

In another embodiment, the equipment may include a cell phone. A reporting application may be provided on a server located at a wireless provider's site. The cell phone within a system such as an organization or for example, within a sales department, may be identified. The activity report then generated may include aggregate information about the identified cell phones, including usage, peak times of use, average length of calls, minutes over allotted plan minutes, etc. The office personnel at the organization may then use the activity report to develop and implement an equipment management strategy based on the information. Examples may be to eliminate cell phones that are underutilized, or switch plans to increase plan minutes or to monitor most frequently called customers.

The Examples below are merely representative of the work that contributes to the teaching of the present disclosure and are not considered to be restrictive of the disclosure.

### EXAMPLES

### Example 1

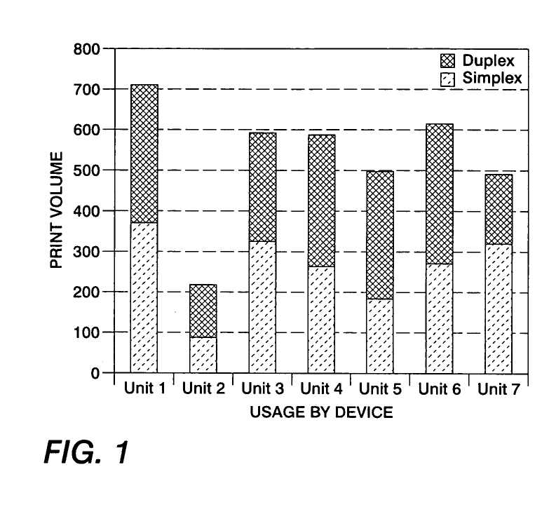

An example of an activity report in accordance with an embodiment is illustrated in FIG. 1. FIG. 1 is a Device Usage Report. In addition to the chart being included in the report, the report also includes the following text including a recommendation: The report illustrates that a total of 3711 pages were produced, of which 1820 were simplex pages. The printed simplex pages represent nearly half of the printed pages. Most printers make duplex prints, therefore changing the default in the printer drivers to “duplex” will reduce paper consumption and improve costs.

Unit 2 is being underutilized. It is capable of making 10,000 prints per month and at current usage rates it is only making less than 900. Other companies have found that changing from desktop printing to workgroup printing has resulted in reduced costs and improved productivity. Inkjet prints cost between $0.25-0.30 each. Unit 2 printer costs are less than $0.10 per page, have higher quality, print documents faster, and are centrally managed. Consider taking an inventory of your desktop inkjet devices and improving productivity and expenditures by using your existing workgroup printers instead.

### Example 2

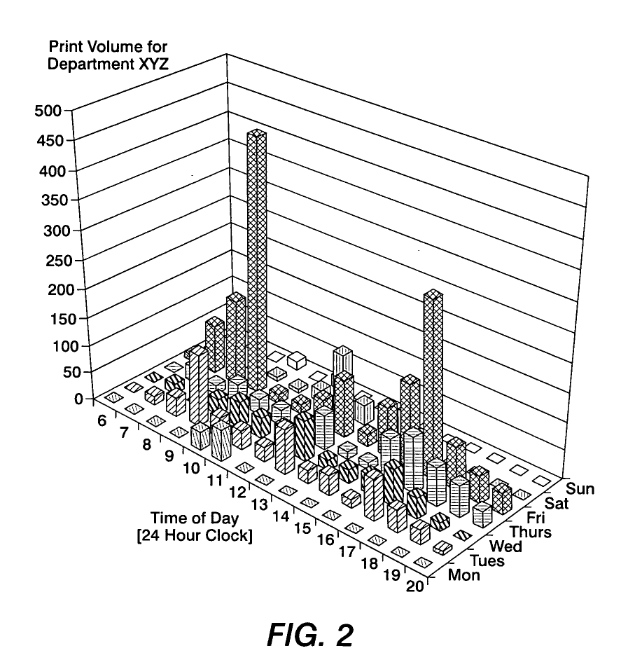

Another example of an activity report is FIG. 2. FIG. 2 illustrates a Peak Demand Report. This report also includes the following text: The printing behaviors in this printer group have been analyzed and a number of patterns have been observed. The report illustrates that there are two times during this reporting period where the demand for printing was greater than normal. Both of these occurred on Thursday. The first is between 7 and 9:00 AM and the second between 4 and 5:00 PM. Demand during these times was more than three times greater than average.

Analysis of the expected waiting times for the printers involved in the higher demand indicates that your employees had to wait as long as 10 minutes to receive their output. During times when job turnaround time is critical, such as immediately prior to important meetings or other scheduled activities, this waiting time can be a hindrance to productivity. You may wish to move Unit 2 printer closer to where it would be better utilized. Alternatively, it may be useful for you to upgrade to a more capable device that can keep up with your printing requirements during times of increased demand. Please call your Document Management Sales Representative, John Smith at (111) 111-1111, to arrange an appointment to talk about your printing needs.

### Example 3

Example 3 includes a text recommendation on the report related to consumables and services. The text may include: Your magenta toner supply for printer A is predicted to have 4 days remaining. Please order this and other supplies at the web site below. To do so, please click on the URL (Universal Resource Locator) to be taken to the web site where the appropriate ordering forms are already filled out.

The disclosure herein provides a number of advantages. For example, the activity report generated may provide valuable information beneficial to the application and device vendor's sales and service support as well as engineering support. For example, certain report information may be distributed to a document management organization for sales or service analysis, with the data being a sales and service enabler, helping to identify an area for sales or an opportunity to upgrade or provide new services. Additionally, from an engineering support perspective, service applications engineering may use incoming data from which to build information and is provided insights to judge the effectiveness of the services provided on the vendor's devices. This allows for continuous improvements, operational effectiveness, as well as new product or service offerings which will fit an organization's business goals. The disclosure thus provides that the aggregation of information from a device and its presentation in a useful form for decision makers to be informed on how the devices within their customer's organizations are being utilized.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of producing an activity report, comprising:
providing a reporting application;
identifying at least one device in a system;
generating the activity report, wherein the activity report comprises aggregate information about the at least one device in the system;
delivering the generated activity report to a remote location from the at least one device; and
providing recommendations about the at least one device generated by a recommendation system utilizing the information from the activity report.

2. The method according to claim 1, wherein the information in the activity report and the recommendations provided, allow a user to make a strategic decision about efficient use of the at least one device.

3. The method according to claim 1, wherein the activity report comprises a summary of the information obtained from at least weekly readings of usage of the at least one device, charts, graphs, tables or combinations thereof.

4. The method according to claim 1, wherein the step of identifying at least one device in the system further comprises identifying a grouping of devices or a number of devices interconnected in a network system with the at least one device comprising a printer, a scanner, a fax machine, a multifunction device, a network router, a network switch, a network file system, a network computational device or a combination thereof.

5. The method according to claim 1, further comprising the step of delivering the activity report in at least one format comprising spreadsheet files, human readable text, or preformatted formats readable by other applications.

6. The method according to claim 1, further comprising the step of delivering the activity report by email, web page, hard copy or a combination thereof.

7. The method according to claim 1, wherein the recommendation system comprises a recommendation engine for producing recommendations.

8. The method according to claim 7, wherein prior to generating the activity report, the recommendation engine tests to see if the recommendation has been implemented within an identified time before restating the recommendation.

9. The method according to claim 1, wherein the recommendation system provides a user with an interface having options for at least accepting or rejecting the recommendation.

10. The method according to claim 1, wherein the activity report is generated by a static or dynamic reporting process.

11. A method for implementing a document management strategy, comprising:
providing a reporting application;
collecting data from at least one device within a network;
generating an activity report, wherein the activity report comprises information about the at least one device and recommendations for increasing efficient usage of the at least one device; and
utilizing the activity report to make decisions.

12. The method according to claim 11, wherein the network comprises a grouping of devices or a number of devices interconnected in a network system, with the at least one device comprising a printer, a scanner, a fax machine, a multifunction device, a network router, a network switch, a network file system, a network computational device or a combination thereof.

13. The method according to claim 11, wherein the decisions comprise performing maintenance, purchasing new devices, upgrading the at least one device, replacing the at least one device or a combination thereof.

14. The method according to claim 11, wherein the activity reports comprises a summary of the information obtained from at least weekly readings of usage of the at least one device, charts, graphs, tables or combinations thereof.

15. The method according to claim 11, further comprising the step of delivering the activity report in at least one format comprising spreadsheet files, human readable text, or preformatted formats readable by other applications.

16. The method according to claim 11, further comprising the step of delivering the activity report by email, web page, hard copy or a combination thereof.

17. An activity report for use in an equipment management system, wherein the activity report provides information about at least one equipment in a network and recommendations, thereby providing the user with the information to make a strategic decision about effectiveness of the at least one equipment in the network.

18. The activity report according to claim 17, wherein the activity report comprises a summary of the information obtained from at least weekly readings of usage of the at least one equipment, charts, graphs, tables or combinations thereof.

19. The activity report according to claim 17, wherein the activity report is delivered in at least one format comprising spreadsheet files, human readable text, or preformatted formats readable by other applications.

20. The activity report according to claim 17, wherein the activity report is delivered by email, web page, hard copy or a combination thereof.
